(19) United States
(12) Patent Application Publication
(10) Pub. No.: US 2015/0216191 A1
(43) Pub. Date: Aug. 6, 2015

(54) BURGER RING PRESS

(71) Applicant: Progressive International Corporation, Kent, WA (US)

(72) Inventor: Lawrence M. Hauser, Auburn, WA (US)

(21) Appl. No.: 14/614,025

(22) Filed: Feb. 4, 2015

Related U.S. Application Data
(60) Provisional application No. 61/936,256, filed on Feb. 5, 2014.

(51) Int. Cl. A22C 7/00

(52) U.S. Cl. CPC A22C 7/0084

(57) ABSTRACT

A burger ring press includes a plunger and a cup, with a plurality of rings configured to be received and retained within the cup for storage. In one version of the invention, the rings are formed in different sizes with the smaller rings concentrically received within a largest ring. The plunger is configured to enclose the cup in order to seal the rings within the cup for storage. The cup may be formed with one or more annular channels in a bottom surface of the cup for receiving one or more of the rings.

### PRIORITY CLAIM

This application claims the benefit of U.S. provisional application Ser. No. 61/936,256 filed Feb. 5, 2014; the contents of which are incorporated by reference.

### FIELD OF THE INVENTION

This application relates to implements for use in food preparation, particularly including implements for forming food patties.

### BACKGROUND OF THE INVENTION

Currently, presses are used for shaping ground beef or other formable food into patties such as for hamburgers. In general, such presses are configured in a single size, making them unsuitable for use in making patties of a variety of sizes, such as for standard large burgers or smaller sliders. As a result, it is awkward and difficult to make patties of a variety of sizes.

### SUMMARY OF THE INVENTION

A preferred burger ring press includes a plunger and a cup, with a plurality of rings configured to be received and retained within the cup for storage.

In one version of the invention, three rings are provided, in which the rings are formed in different sizes with the smaller rings concentrically received within a largest ring.

In an example of the invention, a plunger includes a plate used to press a patty into each one of the rings. The plunger is preferably configured to enclose the cup in order to seal the rings within the cup, with a lock or other surface formed on the cup and/or the plunger to removably retain the plunger atop the cup.

In one version, the cup is formed with one or more annular channels in a bottom surface of the cup for receiving one or more of the rings and for imparting a raised surface to a central portion of a patty formed when using the cup.

### BRIEF DESCRIPTION OF THE DRAWINGS

Preferred and alternative examples of the present invention are described in detail below with reference to the following drawings:

FIG. 1 is a top perspective view of a preferred burger ring press, shown with a plunger in place enclosing a set of rings within a cup.

FIG. 2 is a perspective exploded view of a preferred burger ring press, shown with a set of three rings.

FIG. 3 is a front plan exploded view of the preferred burger ring press as shown in FIG. 2.

FIG. 4 is a top plan view of a preferred burger ring press.

FIG. 5 is a perspective view of a cup for use with a preferred burger ring press.

FIG. 6 is a front plan view of a cup for use with a preferred burger ring press.

FIG. 7 is a sectional view of a cup for use with a preferred burger ring press, taken along plane A-A in FIG. 6.

### DETAILED DESCRIPTION OF THE PREFERRED EMBODIMENT

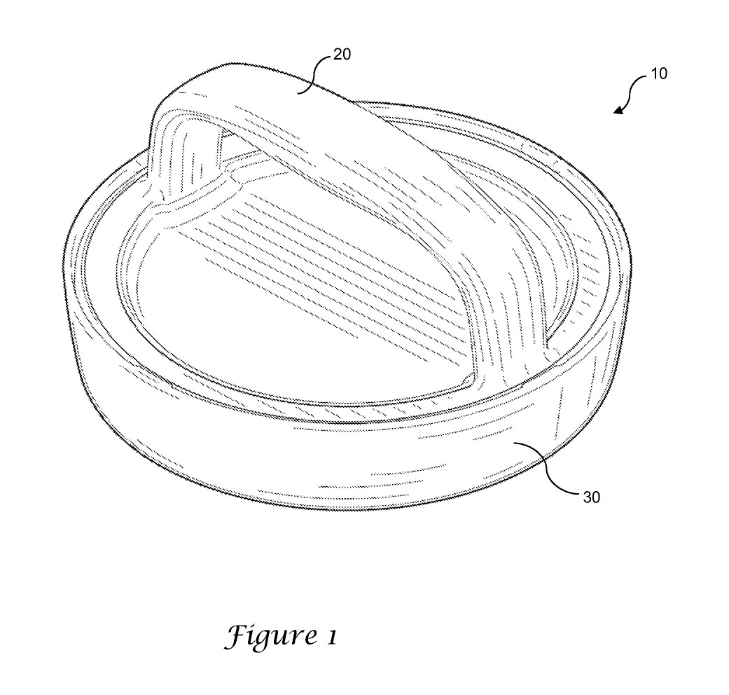

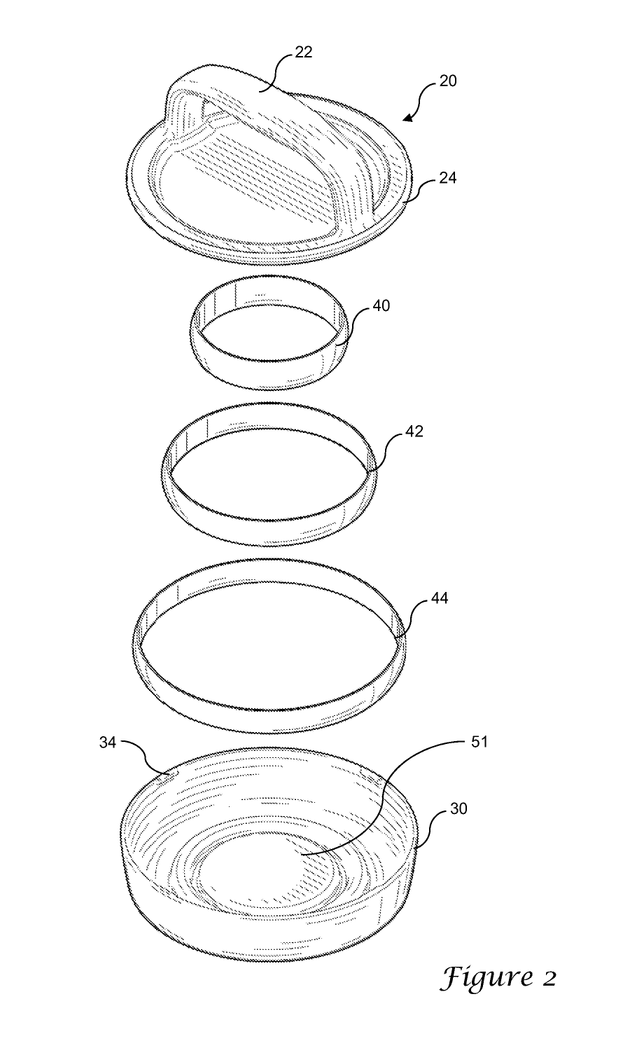

A preferred burger ring press 10 is shown in a storage configuration in FIG. 1, and includes a plunger 20 and a cup 30. As shown in the exploded view of FIG. 2, a plurality of rings 40, 42, 44 is configured to be received within the cup 30 for storage. In the illustrated version, three rings of different sizes are provided in order to allow the formation of burgers of different sizes. In other versions, only two rings may be provided or more than three may be provided. Most preferably, a first smallest ring 40 is formed as a short cylinder having an open top and bottom, and a smallest diameter. A second medium sized ring 42 is also formed as an open cylinder, and having a diameter sufficiently larger than the smallest diameter such that the second ring 42 fits entirely around the first ring 40. A third largest ring 44 has a largest diameter and surrounds both the first and the second rings. Thus, the first and second rings are sized to fit concentrically within the third ring.

The plunger 20 is preferably formed with a handle 22 extending upwardly from a lower plate 24. In the illustrated version, the lower plate is configured to have a circular perimeter and therefore is best suited to create burgers that are generally circular in shape. Most preferably, the plate is formed with a lower surface 26 extending away from the handle in which the lower surface is bulged outward at the center. The convex shape of the center of the lower plate is ideally formed to impart a depression or dimple in the top surface of the burger made when using the plate.

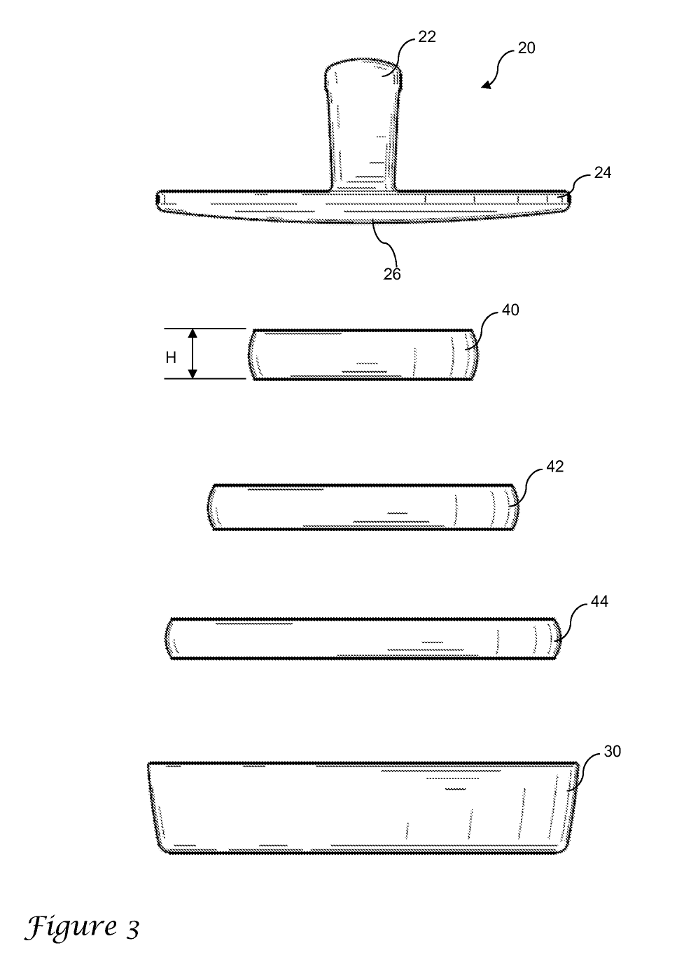

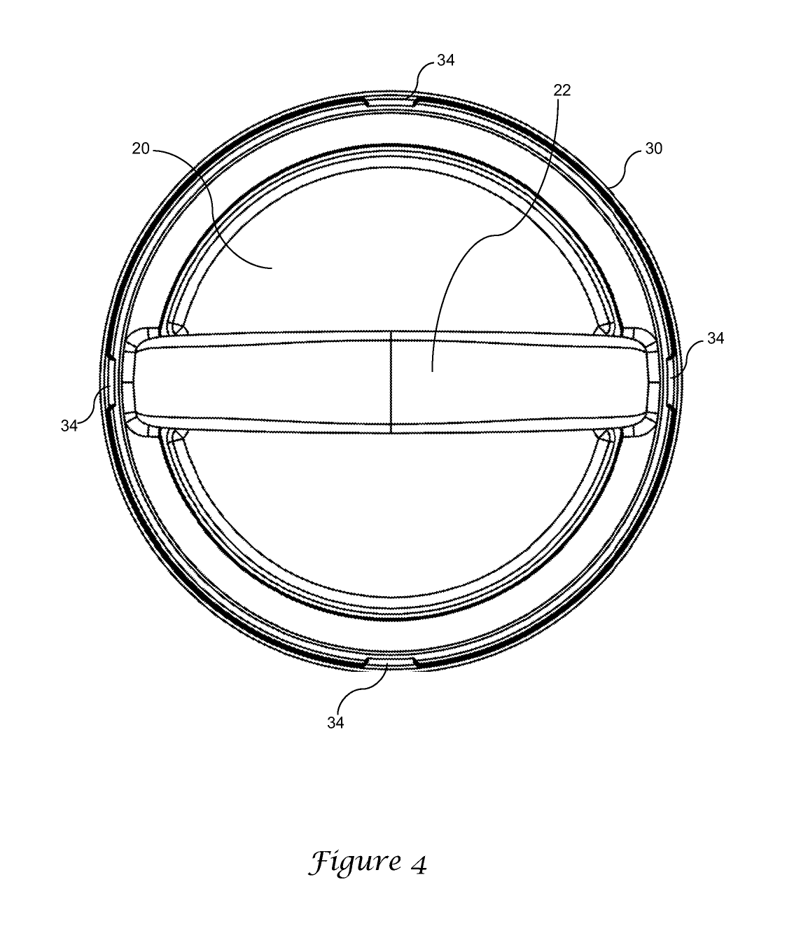

Each of the rings includes a height H (see, for example, ring 40 in FIG. 3) perpendicular to its diameter in which the height of the ring defines the thickness of a hamburger formed using the ring. The heights of the rings may vary as desired, for example, between about ½ inch and 1 inch in preferred versions of the invention. In alternate versions, shorter or taller rings may also be used.

The plunger, rings, and cup are preferably each formed from a food grade plastic material allowing each of the components to be dishwasher safe and food safe. The components may alternatively be formed from metal, wood, or other materials.

Although the rings are circular in the illustrated version, in other versions the rings may be square or have yet a different shape. As such, the term “ring” should not be understood to mean circular, but rather to define an outer sidewall creating an interior space.

A lower cup 30 is formed with a bottom surface and upwardly extending sidewalls to form an open topped short cylinder, such as best seen in FIG. 5. The sidewalls need not be perfectly vertical, however, and may angle outwardly somewhat as they incline upward.

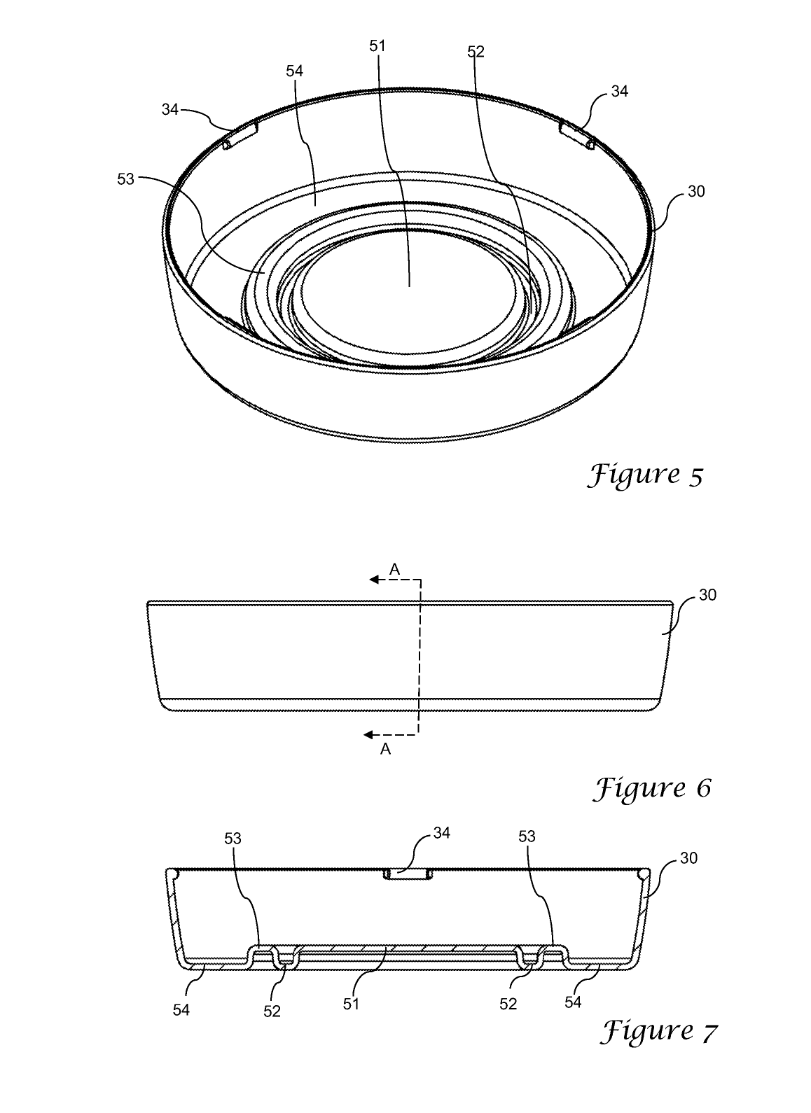

In one version of the invention, and as best seen with reference to FIGS. 5-7, the interior bottom surface of the cup includes grooves or channels sized and shaped to receive one or more of the plurality of rings. Preferably, one or more of the rings fits within the grooves or channels to hold the rings in position and to hinder sliding or lateral motion of the rings when seated in the cup. In the illustrated version, the cup 30 includes a central annular channel 52 sized to receive the smallest ring 40 within the channel The central annular channel surrounds a raised dome 51 positioned in the center of the floor of the cup. An annular rib 53 is formed at a position radially outward from the central annular channel 52, such that the annular rib 53 surrounds the annular channel 52. The annular rib transitions to a peripheral annular channel 54 forming the lower floor of the cup at a position radially outward from the annular rib.

The outer vertical sidewall of the annular rib is configured to abut the interior vertical sidewall of the middle sized ring 42, while the outer vertical sidewall of the largest ring 44 will abut the inner sidewall of the cup 30. The smallest ring 40 is configured to seat within the central annular channel 52. In this fashion, the three rings are all sized to be held in place by a feature formed on the bottom of the cup, retaining them in a relatively fixed position for storage.

In alternate versions of the invention, the cup may be formed with a flat bottom that does not include features for retaining the rings in place. In yet other versions, the cup may include ribs or other features to hold the rings in place. Most preferably, the height of the cup is configured so that the lower surface of the plate of the plunger is pressed against the rings when the plunger is attached to the cup. Accordingly, the height of the rings and the depth of the channel as described above are configured to interact with the depth of the convex shape of the plate to allow for a snug fit of the plunger atop the rings and in the cup.

An upper rim of the cup includes one or more locks or other elements that interact with the plunger plate in order to hold the plunger within the cup. In the illustrated version, the upper rim of the cup includes four separate tabs 34 extending radially inward from an inner surface of the cup adjacent the rim. The tabs are preferably positioned at the height of the rim, though they may be positioned just above or somewhat below the rim. Most preferably, the diameter of the plunger plate is approximately equal to the diameter of the cup at a height just below the tabs 34 formed on the cup. Thus, the inwardly directed tabs will impede upward movement of the plunger, thereby holding the plunger within the cup.

In order to store the plunger and rings, each of the plurality of rings is placed within the interior space defined by the cup and then the plunger is pressed down against the set of rings. The downward force will cause a slight outward deflection of the sidewall of the cup, thereby allowing the plunger to snap fit in place. In order to remove the plunger, a user can squeeze the upper sidewall of the cup to distort the cup out of its circular or cylindrical shape, thereby separating one or more of the inwardly directed tabs from the plunger. In order to facilitate this form of storage and removal, preferably the cup is formed from a material that allows the cup to the deformed at least somewhat under a squeezing or prying force.

In use, a user removes the plunger from the cup and selects any one or more of the rings in order to form hamburgers from ground beef or to form patties from other compressible foods. The selected ring is placed directly on a countertop or on a cutting board, and a suitable amount of ground beef is placed within the ring. The plunger and plunger plate are pressed downward onto the ground beef, causing it to flow outward where eventually it is pressed against the interior sidewalls of the ring and the top of the plunger, thereby forming a disk shape for the hamburger. Once finished, the rings can be cleaned and returned to the cup with the plunger attached to the top of the cup for storage.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A burger ring press, comprising:
a cup having a bottom and upwardly extending sidewalls terminating in a rim;
a plurality of rings sized to fit within the cup in a concentric fashion in which a smallest ring fits within a largest ring from among the plurality of rings, each of the rings having an open top and an open bottom; and
a plunger having a handle and a plunger plate, the plunger being removably attachable to the cup, and further being sized to enclose the plurality of rings within the cup when the plunger is attached to the cup.

2. The burger ring press of claim 1, wherein the plurality of rings further comprises an intermediate ring, and further wherein the smallest ring fits concentrically within the intermediate ring and the intermediate ring fits within the largest ring.

3. The burger ring press of claim 2, wherein each of the plurality of rings is in the form of a short upright cylinder having a circular cross section.

4. The burger ring press of claim 2, wherein the plunger plate comprises a lower surface opposite the handle, the lower surface being bowed outward at a central location.

5. The burger ring press of claim 3, wherein the bottom of the cup further comprises an abutment for impeding lateral movement of at least one of the plurality of rings when the plurality of rings are positioned within the cup.

6. The burger ring press of claim 5, wherein the abutment comprises a central annular channel.

7. The burger ring press of claim 6, wherein the abutment further comprises a peripheral annular channel.

8. The burger ring press of claim 2, further comprising a lock for retaining the plunger atop the cup.

9. The burger ring press of claim 8, wherein the lock comprises a plurality of inwardly extending tabs positioned on an upper portion of the sidewall of the cup.

10. A burger ring press, comprising:
a cup having a bottom and upwardly extending sidewalls terminating in a rim;
a first ring having an open top and an open bottom;
a second ring having an open top and an open bottom;
a third ring having an open top and an open bottom;
the first ring being sized to fit within the cup, the second ring being sized to fit within the cup and within the first ring, the third ring being sized to fit within the cup and within the second ring; and
a plunger having a handle and a plunger plate, the plunger plate being removably attachable to the cup adjacent the rim to enclose the plurality of rings within the cup when the plunger is attached to the cup.

11. The burger ring press of claim 10, wherein each of the first ring, the second ring, and the third ring is in the form of a short upright cylinder having a circular cross section.

12. The burger ring press of claim 10, wherein the plunger plate comprises an upper surface and a lower surface, the lower surface being bowed outward.

13. The burger ring press of claim 10, wherein the bottom of the cup further comprises at least one channel for impeding lateral movement of at least one of the first ring, the second ring, or the third ring.

14. The burger ring press of claim 13, wherein the at least one channel comprises a central annular channel.

15. The burger ring press of claim 10, wherein the bottom of the cup further comprises at least one rib for impeding lateral movement of at least one of the first ring, the second ring, or the third ring.

16. The burger ring press of claim 15, wherein the at least on rib comprises an annular rib.

17. The burger ring press of claim 10, further comprising a retaining surface formed on the cup for retaining the plunger atop the cup.

18. The burger ring press of claim 17, wherein the retaining surface comprises a plurality of inwardly extending tabs positioned on an upper portion of the sidewall of the cup.
